(19) United States
(12) Patent Application Publication
(10) Pub. No.: US 2026/0035280 A1
(43) Pub. Date: Feb. 5, 2026

(54) METHOD OF MANUFACTURING WINDOW GLASS

(71) Applicant: Samsung Display Co., Ltd., Yongin-si (KR)

(72) Inventors: BYOUNGYUL SHIM, Yongin-si (KR); KANG DUK CHOI, Yongin-si (KR); SEUNGPYO HONG, Yongin-si (KR)

(21) Appl. No.: 19/258,392

(22) Filed: Jul. 2, 2025

(30) Foreign Application Priority Data
Aug. 5, 2024 (KR) 10-2024-0103931

(51) Int. Cl. C03B 23/023; B24B 7/24; C03B 33/023; C03C 21/00

(52) U.S. Cl. CPC C03B 23/023; B24B 7/241; C03B 33/023; C03C 21/002

(57) ABSTRACT

A manufacturing method of a window glass includes providing a window glass including a folding portion and non-folding portions spaced apart from each other with the folding portion interposed therebetween, heating the window glass to make the folding portion in a bent state, and polishing one surface of the folding portion in the bent state.

This application claims priority to Korean Patent Application No. 10-2024-0103931, filed on Aug. 5, 2024, and all the benefits accruing therefrom under 35 U.S.C. § 119, the content of which in its entirety is herein incorporated by reference.

### BACKGROUND

### 1. Field

The present disclosure relates to a method of manufacturing a window glass for a display device. More particularly, the present disclosure relates to a method of manufacturing a window glass included in a foldable electronic device.

### 2. Description of Related Art

Various types of electronic devices, such as television sets, mobile phones, tablet computers, game units, or the like, are being developed. Recently, flexible electronic devices including a flexible display panel that is slidable or foldable are being developed.

Components included in the flexible electronic device are required to be designed to implement folding characteristics of the electronic device. Accordingly, a window glass applied to the flexible electronic device is required to have improved folding characteristics in a folding area.

### SUMMARY

The present disclosure provides a window glass provided with a groove defined therein through a polishing process after thermoforming of the window for a display device.

The present disclosure provides a method of manufacturing a window glass, which is capable of relieving an internal stress when a display device is folded.

Embodiments of the invention provide a method of manufacturing a window glass. The method includes providing a window glass including a folding portion and non-folding portions spaced apart from each other with the folding portion interposed therebetween, heating the window glass to male the folding portion in a bent state, and polishing one surface of the folding portion in the bent state.

The window glass may include a glass material, and the folding portion may be heated at a temperature equal to or greater than about 500° C. and equal to or smaller than about 750° C. in the heating of the window glass.

The window glass may be heated for a time equal to or longer than about 10 seconds and equal to or shorter than about 120 seconds in the heating of the window glass.

The polishing of the one surface of the folding portion may include providing a multi-axis polishing machine and forming a groove in the folding portion using the multi-axis polishing machine.

The multi-axis polishing machine may include a jig unit including a first plate, which moves in first and second directions intersecting with each other in a plan view, and a jig part disposed on the first plate and rotatable and a polishing unit including a second plate spaced apart from the first plate in a third direction intersecting the first and second directions and including a first surface facing the first plate and a second surface opposite to the first surface, a first polishing wheel disposed on the first surface and rotatable, and a second polishing wheel disposed on the second surface and rotatable.

The forming of the groove may include fixing the window glass onto the jig part, moving the first polishing wheel in a direction toward the folding portion to allow the first polishing wheel to be in contact with the folding portion, and rotating the first polishing wheel to polish the one surface of the folding portion.

The forming of the groove further may include providing the second polishing wheel in the direction toward the folding portion, moving the second polishing wheel in the direction toward the folding portion to allow the second polishing wheel to be in contact with the folding portion, and rotating the second polishing wheel to polish the one surface of the folding portion.

Each of the first and second polishing wheels may include a polishing brush or a polishing pad.

The folding portion may include a flat portion and slant portions spaced apart from each other with the flat portion interposed therebetween and slant to the flat portion from the non-folding portion, which are formed by the forming of the groove.

A first end and a second end of each of the slant portions may have a predetermined curvature in a cross-sectional view, the first end may be adjacent to a corresponding one of the non-folding portions, and the second end may be adjacent to the flat portion.

The one surface of the folding portion may extend from first surfaces of the non-folding portions, which face each other in the bent state, or second surfaces of the non-folding portions opposite to the first surfaces.

The window glass may have a thickness equal to or greater than about 0.05millimeters (mm) and equal to or smaller than about 0.6 mm in the providing of the window glass.

After the polishing of the one surface of the folding portion, the folding portion may have a thickness equal to or greater than about 0.03 mm and equal to or smaller than about 0.1 mm, and the thickness of the folding portion may be smaller than a thickness of each of the non-folding portions.

The method may further include, before the providing of the window glass, providing a window mother glass and cutting the window mother glass.

The cutting of the window mother glass may include performing one of a scribing process, a waterjet process, and a laser cutting process on the window mother glass to cut the window mother glass and processing a cut surface of the cut window mother glass using a computer numerical control process.

In the bent state, an angle between portions of a surface of the non-folding portions facing each other may be equal to or smaller than about 90 degrees.

A first impact absorbing member may be disposed between the non-folding portions.

The window glass may be provided in plural, the method may further include a stacking process after the heating of the window glass and before the polishing of the one surface, and in the staking process, the plurality of window glasses may be alternately stacked with second impact absorbing members therebetween.

The method may further include providing a first side polishing wheel including a first side rotation axis and a second side polishing wheel including a second side rotation axis parallel to the first side rotation axis and moving plurality of the window glasses between the first side polishing wheel and the second side polishing wheel while the plurality of window glasses is in contact with the first and second side polishing wheels to polish side surfaces of the plurality of window glasses.

The moving of the plurality of window glasses may further include rotating the first side polishing wheel to polish edges of the window glass and rotating the second side polishing wheel to polish the folding portion of each of the plurality of window glasses, and the polishing of the edges and the polishing of the folding portion may be substantially simultaneously performed.

The method may further include replacing first ions of the polished window glass with second ions different from the first ions to chemically strengthen the window glass.

According to the above, the method of manufacturing the window glass reduces the cost and time required to manufacture the window glass and provides the window glass with improved foldable characteristics by alleviating internal stress occurring in the folded state.

### BRIEF DESCRIPTION OF THE DRAWINGS

The above and other advantages of the present disclosure will become readily apparent by reference to the following detailed description when considered in conjunction with the accompanying drawings wherein:

FIG. 1A is a perspective view of an electronic device according to an embodiment of the present disclosure;

FIG. 1B is a perspective view of a folding operation of an electronic device according to an embodiment of the present disclosure;

FIG. 1C is a plan view of an electronic device in a folded state according to an embodiment of the present disclosure;

FIG. 1D is a perspective view of a folding operation of an electronic device according to an embodiment of the present disclosure;

FIG. 2A is a perspective view of an electronic device according to an embodiment of the present disclosure;

FIGS. 2B and 2C are perspective views of a folding operation of an electronic device according to an embodiment of the present disclosure;

FIG. 3 is an exploded perspective view of the electronic device according to an embodiment of the present disclosure;

FIG. 4 is a cross-sectional view of a display module taken along line I-I′ of FIG. 3;

FIG. 5 is a flowchart illustrating a method of manufacturing a window glass according to an embodiment of the present disclosure;

FIG. 6 is a flowchart illustrating processes of a method of manufacturing a window glass according to an embodiment of the present disclosure;

FIG. 7 is a flowchart illustrating processes of a method of manufacturing a window glass according to an embodiment of the present disclosure;

FIGS. 8 to 16 are views illustrating processes of a method of manufacturing a window glass according to an embodiment of the present disclosure;

FIG. 17 is a perspective view of a window glass according to an embodiment of the present disclosure;

FIG. 18 is a perspective view of a window glass according to an embodiment of the present disclosure;

FIG. 19 is a cross-sectional view taken along line III-III′ of FIG. 18;

FIG. 20 is a view illustrating processes of a method of manufacturing a window glass according to an embodiment of the present disclosure; and

FIGS. 21 and 22 are views illustrating processes of a method of manufacturing a window glass according to an embodiment of the present disclosure.

### DETAILED DESCRIPTION

The present disclosure may be variously modified and realized in many different forms, and thus specific embodiments will be exemplified in the drawings and described in detail hereinbelow. However, the present disclosure should not be limited to the specific disclosed forms, and be construed to include all modifications, equivalents, or replacements included in the spirit and scope of the present disclosure.

In the present disclosure, it will be understood that when an element (or area, layer, or portion) is referred to as being “on”, “connected to” or “coupled to” another element or layer, it can be directly on, connected or coupled to the other element or layer or intervening elements or layers may be present.

Like numerals refer to like elements throughout. In the drawings, the thickness, ratio, and dimension of components are exaggerated for effective description of the technical content. As used herein, the term “and/or” may include any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the present disclosure. As used herein, the singular forms, “a”, “an” and “the” are intended to include the plural forms as well, unless the context clearly indicates otherwise.

Spatially relative terms, such as “beneath”, “below”, “lower”, “above”, “upper” and the like, may be used herein for ease of description to describe one element or feature's relationship to another elements or features as shown in the figures.

It will be further understood that the terms “include” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

“About” or “substantially simultaneously” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” or “substantially simultaneously” can mean within one or more standard deviations, or within ±10%, 5% or 2% of the stated value. Hereinafter, embodiments of the present disclosure will be described with reference to accompanying drawings.

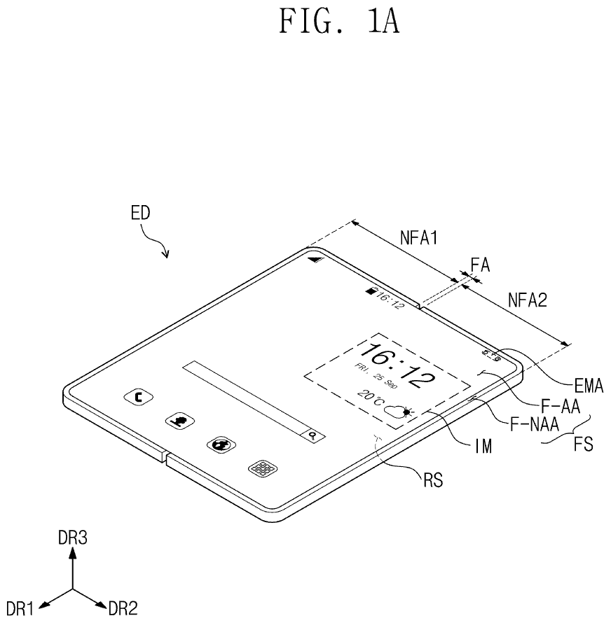

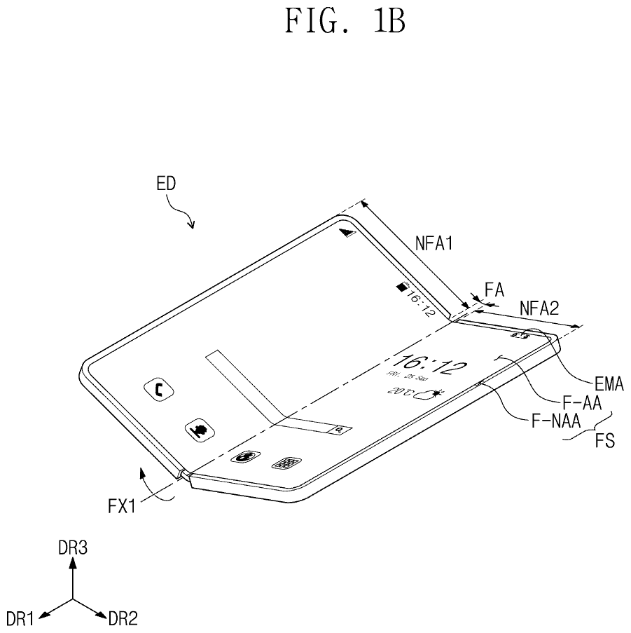

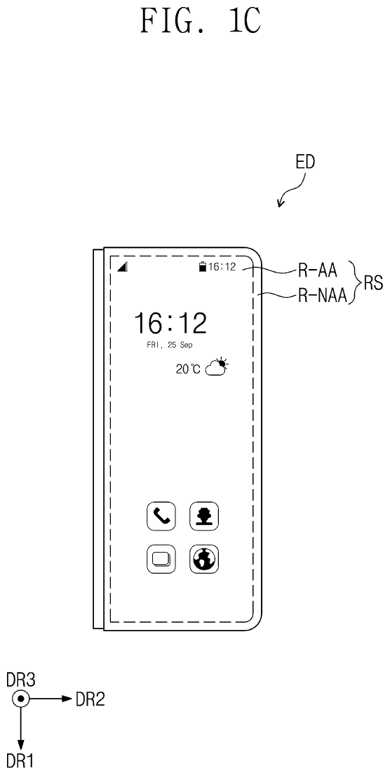

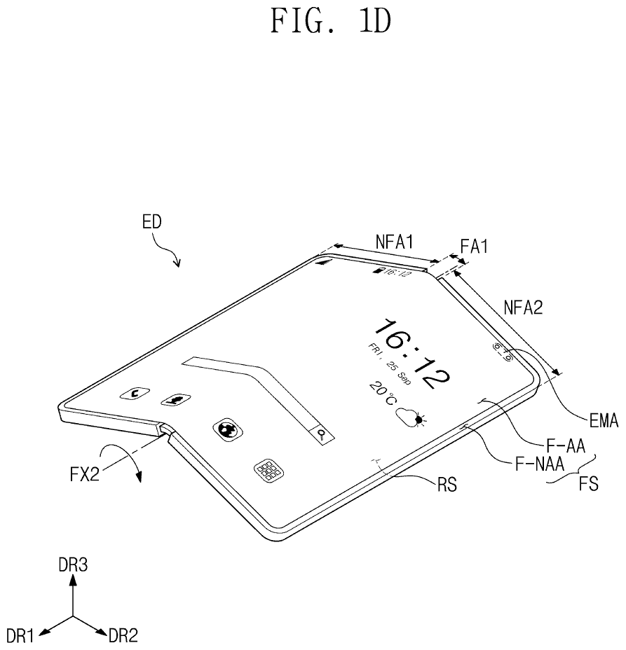

FIG. 1A is a perspective view of an electronic device ED according to an embodiment of the present disclosure.

FIG. 1A is a perspective view of the electronic device ED in an unfolded state according to an embodiment of the present disclosure.

The electronic device ED may be a device that is activated in response to electrical signals. As an example, the electronic device ED may be a mobile phone, a tablet computer, a car navigation unit, a game unit, or a wearable device, however, it should not be limited thereto or thereby. FIG. 1A shows a foldable electronic device ED as a representative example. In FIGS. 1A to 1D, the mobile phone is shown as a representative example of the foldable electronic device ED.

The electronic device ED may include a first display surface FS defined by a first direction DR1 and a second direction DR2 intersecting the first direction DR1. The electronic device ED may provide an image IM to a user through the first display surface FS. The electronic device ED may display the image IM through the first display surface FS, which is substantially parallel to each of the first direction DR1 and the second direction DR2, toward a third direction DR3.

In the present disclosure, the first direction DR1 may be perpendicular to the second direction DR2, and a third direction DR3 may be a normal line direction with respect to a plane defined by the first direction DR1 and the second direction DR2. A thickness direction of the electronic device ED may be substantially parallel to the third direction DR3. A front surface (or upper surface) and a rear surface (or lower surface) may be opposite to each other in the third direction DR3, and a normal line direction of each of the front surface (or upper surface) and the rear surface (or lower surface) may be substantially parallel to the third direction DR3.

The front surface (or upper surface) may indicate a surface relatively closer to the first display surface FS, and the rear surface (or lower surface) may indicate a surface relatively far away from the first display surface FS. In addition, the rear surface (or lower surface) may indicate the surface restively closer to a second display surface RS described later. An upper side (or upper portion) may indicate a direction approaching the first display surface FS, and a lower side (or lower portion) may indicate a direction away from the first display surface FS.

A cross-section of each component refers to a flat surface parallel to the thickness direction DR3, and a plane of each component refers to a flat surface perpendicular to the thickness direction DR3. The plane refers to a flat surface defined by the first direction DR1 and the second direction DR2.

The electronic device ED may sense an external input applied thereto from an outside thereof. The external input may include various forms of inputs provided from the outside of the electronic device ED. For example, the external inputs may include a proximity input (e.g., hovering) applied when approaching close to or adjacent to the electronic device ED at a predetermined distance as well as a touch input by a user's body (e.g., user's hand). In addition, the external inputs may be provided in the form of force, pressure, temperature, light, etc.

The electronic device ED may include the first display surface FS and the second display surface RS. The first display surface FS may include a first active area F-AA, a first peripheral area F-NAA, and an electronic module area EMA. The second display surface RS may be opposite to at least a portion of the first display surface FS. That is, the second display surface RS may be defined as a portion of a rear surface of the electronic device ED.

The first active area F-AA may be activated in response to the electrical signals. The electronic device ED may display the image IM through the first active area F-AA, and various external inputs may be sensed through the first active area F-AA.

The image IM may not be displayed through the first peripheral area F-NAA. The first peripheral area F-NAA may be defined adjacent to the first active area F-AA. The first peripheral area F-NAA may have a predetermined color. The first peripheral area F-NAA may surround the first active area F-AA. Accordingly, the first active area F-AA may have a shape that is substantially defined by the first peripheral area F-NAA, however, this is merely one example. The first peripheral area F-NAA may be defined adjacent to only one side of the first active area F-AA or may be omitted.

Various electronic modules may be disposed in the electronic module area EMA. For example, the electronic module may include at least one of a camera, a speaker, an optical sensor, and a thermal sensor. An external object may be sensed through the electronic module area EMA of the first display surface FS or the second display surface RS, or a sound signal, such as a voice, may be provided to the outside through the electronic module area EMA of the first display surface FS or the second display surface RS. In addition, the electronic module may include a plurality of components, however, it should not be limited to a particular embodiment.

The electronic module area EMA may be surrounded by the first peripheral area F-NAA, however, it should not be limited thereto or thereby. As an example, the electronic module area EMA may be surrounded by the first active area F-AA and the first peripheral area F-NAA, and the electronic module area EMA may be defined in the first active area F-AA.

The electronic device ED may include at least one folding area FA and a plurality of non-folding areas NFA1 and NFA2 extending from the folding area FA. As an example, a first non-folding area NFA1, the folding area FA, and a second non-folding area NFA2 may be sequentially defined along the second direction DR2. The second non-folding area NFA2 may be spaced apart from the first non-folding area NFA1 in the second direction DR2 with the folding area FA interposed therebetween. For example, the first non-folding area NFA1 may be disposed adjacent to one side of the folding area FA in the second direction DR2, and the second non-folding area NFA2 may be disposed adjacent to the other side of the folding area FA in the second direction DR2.

FIG. 1A shows the structure in which the electronic device ED includes one folding area FA as a representative example, however, the present disclosure should not be limited thereto or thereby, and the electronic device ED may include a plurality of folding areas defined therein. As an example, the electronic device may include two or more folding areas and three or more non-folding areas arranged with the folding area interposed therebetween.

FIG. 1B is a perspective view of a folding operation of the electronic device ED according to an embodiment of the present disclosure. FIG. 1C is a plan view of the electronic device ED in a folded state according to an embodiment of the present disclosure. FIG. 1D is a perspective view of a folding operation of the electronic device ED according to an embodiment of the present disclosure.

Referring to FIG. 1B, the electronic device ED may be folded with respect to a first folding axis FX1 extending in the first direction DR1. When the electronic device ED is folded, the folding area FA may have a predetermined curvature and a radius of curvature. The electronic device ED may be inwardly folded (in-folding) with respect to the first folding axis FX1 to allow the first non-folding area NFA1 to face the second non-folding area NFA2 and the first display surface FS not to be exposed to the outside.

Referring to FIG. 1C, the second display surface RS may be viewed by the user when the electronic device ED is inwardly folded. In this case, the second display surface RS may include a second active area R-AA through which images are displayed. The second active area R-AA may be activated in response to electrical signals. The images may be displayed through the second active area R-AA, and various external inputs may be sensed through the second active area R-AA.

In addition, the second display surface RS may include a second peripheral area R-NAA. The second peripheral area R-NAA may be defined adjacent to the second active area R-AA. The second peripheral area R-NAA may have a predetermined color. The second peripheral area R-NAA may surround the second active area R-AA. Although not shown in figures, the electronic device ED may further include an electronic module area in which an electronic module including various components is disposed in the second display surface RS.

According to an embodiment, when the electronic device ED is inwardly folded, a distance between the first non-folding area NFA1 and the second non-folding area NFA2 may be smaller than the radius of the circle defined by the radius of curvature of the folding area FA. In this case, the folding area FA may be folded to have a dumbbell shape, and the distance between the first non-folding area NFAl and the second non-folding area NFA2 may be reduced. Accordingly, the electronic device ED may be slimmed down in the folded state.

Referring to FIG. 1D, the electronic device ED may be folded with respect to a second folding axis FX2 extending in the first direction DR1. The electronic device ED may be outwardly folded (out-folding) with respect to the second folding axis FX2 to allow the first display surface FS to be exposed to the outside. The display devices ED may be configured to repeat the unfolding operation and the in-folding operation or to repeat the unfolding operation and the out-folding operation, however, the present disclosure should not be limited thereto or thereby.

Meanwhile, FIGS. 1A to 1D show the electronic device ED folded with respect to one folding axis FX1 or FX2, however, the number of the folding axes and the number of non-folding areas should not be particularly limited. As an example, the electronic device ED may be folded with respect to multiple folding axes to allow a portion of the first display surface FS to face another portion of the first display surface FS and a portion of the second display surface RS to face another portion of the second display surface RS. In addition, the first and second folding axes FX1 and FX2 are shown as being parallel to long sides of the electronic device ED in the above embodiments, however, the present disclosure should not be limited thereto or thereby. According to an embodiment, the first and second folding axes FX1 and FX2 may be substantially parallel to short sides of the electronic device ED.

In the electronic device ED, the first non-folding area NFA1 and the second non-folding area NFA2 may be defined as areas respectively including the display surfaces FS and RS parallel to the plane defined by the first direction DR1 and the second direction DR2 in the folded state as shown in FIG. 1D, and the folding area FA may be defined as an area between the first non-folding area NFA1 and the second non-folding area NFA2. The folding area FA may include a curved portion that has a predetermined curvature in the folded state.

A conventional foldable electronic device includes a window glass whose basic shape is the unfolded form when no external force is applied. However, the foldable electronic device is used by the user in the “folded state” for longer periods of time, such as, when being carried, left unused, or used to view images through a second active area (refer to R-AA of FIG. 1C), than it is used in the “unfolded state”. In this case, an internal stress of the window glass, which has the unfolded form as its basic shape, increases in the folded state, leading to a deterioration in the reliability of the electronic device.

However, according to the method of manufacturing the window glass of the present disclosure, the window glass is formed to have a folded state at a certain angle as its basic shape through a thermal forming process, and then a polishing process is performed on the folded window glass. Thus, the thickness of the electronic device ED in the folding area FA (refer to FIG. 1B) may be simply reduced. Therefore, according to the window glass manufactured by the present disclosure, the internal stress of the electronic device in the folded state may be relieved, and the folding characteristics of the electronic device may be improved. In addition, the reliability of the electronic device may be improved.

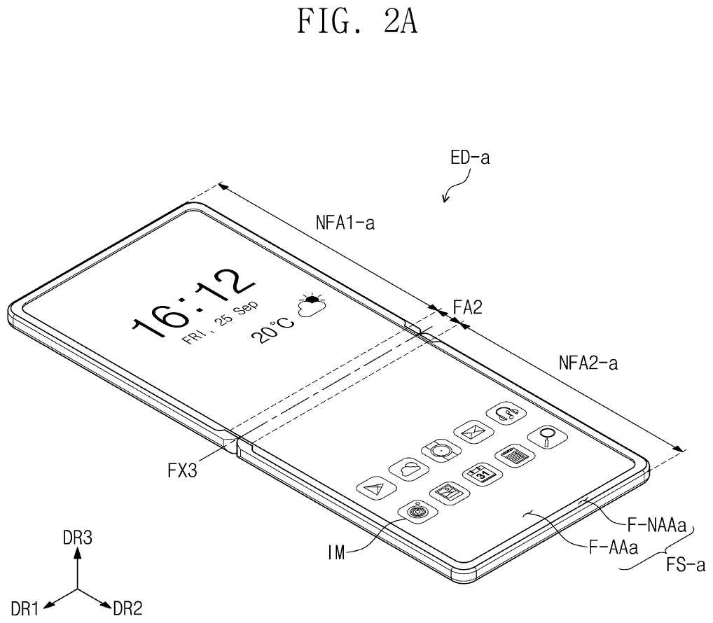

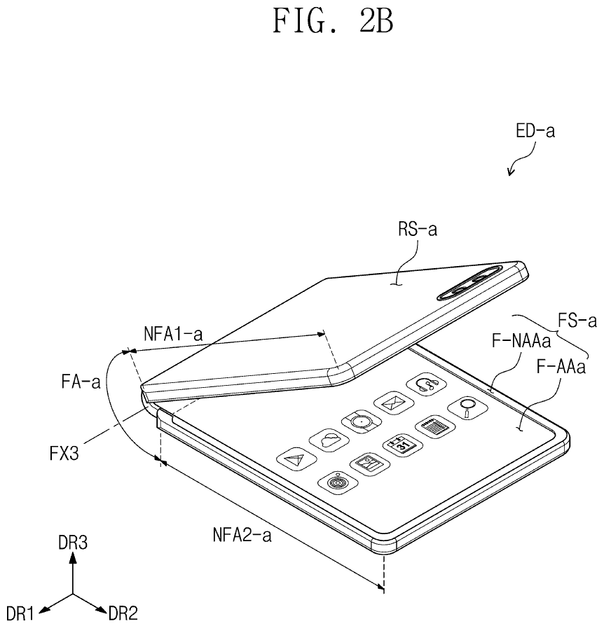

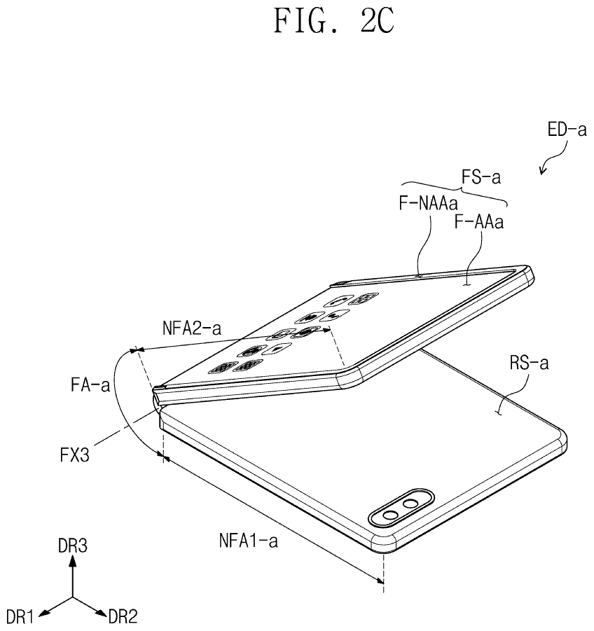

FIGS. 2A to 2C are perspective views of an electronic device ED-a.

FIG. 2A is a perspective view of the electronic device ED-a according to an embodiment of the present disclosure. FIG. 2A is a perspective view of the electronic device ED-a in an unfolding state. FIGS. 2B and 2C are perspective views illustrating a folding operation of the electronic device ED-a. FIG. 2B is a perspective view illustrating an in-folding operation of the electronic device ED-a shown in FIG. 2A. FIG. 2C is a perspective view illustrating an out-folding operation of the electronic device ED-a shown in FIG. 2A. FIG. 2B illustrates the electronic device ED-a in a first mode, and FIG. 2C illustrates the electronic device ED-a in a second mode.

Referring to FIG. 2A, the electronic device ED-a may be folded with respect to a third folding axis FX3 extending in a direction substantially parallel to the first direction DR1. The direction in which the third folding axis FX3 extends may be substantially parallel to a direction in which a short side of the electronic device ED-a extends.

The electronic device ED-a may include a folding area FA-a, a first non-folding area NFA1-a adjacent to one side of the folding area FA-a, and a second non-folding area NFA2-a adjacent to the other side of the folding area FA-a. The first non-folding area NFA1-a may be spaced apart from the second non-folding area NFA2-a with the folding area FA-a interposed therebetween.

The folding area FA-a may be folded with respect to the third folding axis FX3. When the electronic device ED-a is folded, the folding area FA-a may have a predetermined curvature and a radius of curvature. The electronic device ED-a may be inwardly folded (in-folding) to allow the first non-folding area NFA1-a to face the second non-folding area NFA2-a and a display surface FS-a not to be exposed to the outside.

Referring to FIG. 2A, the display surface FS-a may be viewed by the user when the electronic device ED-a is in an unfolding state. Similar to the descriptions with reference to FIGS. 1A to 1D, the display surface FS-a of the electronic device ED-a may include an active area F-AAa and a peripheral area F-NAAa. An image IM may be displayed through the active area F-AAa, and various external inputs may be sensed through the active area F-AAa.

Referring to FIG. 2B, a rear surface RS-a may be viewed by the user when the electronic device ED-a is inwardly folded. As an example, the rear surface RS-a may function as a second display surface through which images are displayed. In addition, the rear surface RS-a may include an electronic module area in which an electronic module including various components is disposed. An active area through which images are displayed may be further defined in the rear surface RS-a of the electronic device ED-a.

Referring to FIG. 2C, the electronic device ED-a may be folded with respect to the third folding axis FX3 to allow a portion of the rear surface RS-a, which overlaps the first non-folding area NFA1-a, to face another portion of the rear surface RS-a, which overlaps the second non-folding area NFA2-a.

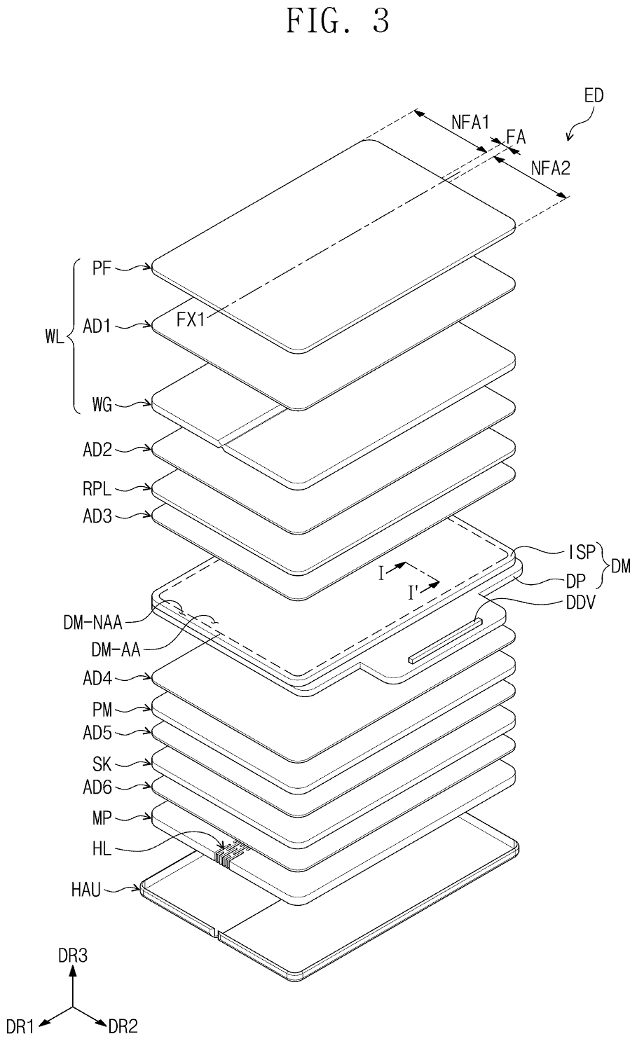

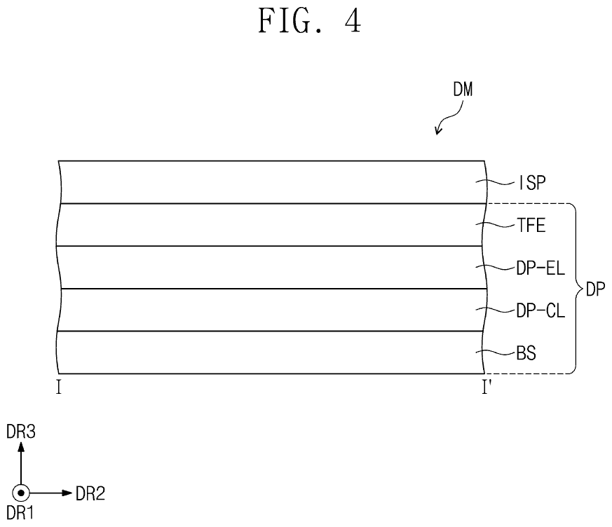

FIG. 3 is an exploded perspective view of the electronic device ED according to an embodiment of the present disclosure, and FIG. 4 is a cross-sectional view of a display module DM taken along line I-I′ of FIG. 3. The following descriptions on the electronic device ED may be applied to the electronic device ED-a described with reference to FIGS. 2A to 2C.

Referring to FIG. 3, the electronic device ED may include a window WL, the display module DM, an optical layer RPL, a lower film PM, a support plate SK, a lower plate MP, and a housing HAU.

The housing HAU may be coupled with the window WL to define an exterior of the electronic device ED. The housing HAU may include a material with relatively high rigidity. As an example, the housing HAU may include a plurality of frames and/or plates formed of a glass, plastic, or metal material. The housing HAU may provide a predetermined accommodation space. The display module DM may be accommodated in the accommodation space and may be protected from external impacts. According to an embodiment, the housing HAU may further include a hinge structure disposed overlapping the folding area FA to guide the folding operation of the electronic device ED.

The display module DM may be disposed under the optical layer RPL. The display module DM may be activated in response to electrical signals. The activated display module DM may display the image IM (refer to FIG. 1A) through the first active area F-AA (refer to FIG. 1A) of the electronic device ED. The display module DM may include a display area DM-AA and a non-display area DM-NAA defined therein. The display area DM-AA may be activated in response to electrical signals. The non-display area DM-NAA may be defined adjacent to at least one side of the display area DM-AA. Circuits or lines to drive the display area DM-AA may be disposed in the non-display area DM-NAA.

The optical layer RPL may be disposed between the display module DM and the window WL. The optical layer RPL may be an anti-reflective layer to reduce a reflectance of the display module DM with respect to an external light incident to the display module DM from the outside. The optical layer RPL may be formed on the display module DM through successive processes. The optical layer RPL may include a polarizing plate or a color filter layer. As an example, the optical layer RPL may include at least one of a retarder, a polarizer, a polarizing film, and a polarizing filter. According to an embodiment, the optical layer RPL may include a plurality of color filters arranged in a predetermined arrangement and a black matrix disposed adjacent to the color filters.

The image IM (refer to FIG. 1A) generated by the display module DM may be provided to the user after passing through the window WL. The window WL may include a polymer substrate or a glass substrate.

The window WL may include a protective layer PF and the window glass WG. The protective layer PF and the window glass WG may include an optically transparent insulating material. In the present embodiment, the window WL may include a glass material.

The protective layer PF may be disposed above the window glass WG. The protective layer PF may serve as a functional layer to protect an upper surface of the window glass WG. The protective layer PF may include a polymer film.

The window glass WG may have a shape in which a portion overlapping the folding area FA is etched in both directions parallel to the third direction DR3, i.e., the third direction DR3 and its opposite direction.

The lower film PM may protect a lower portion of a display panel DP. The lower film PM may include a flexible plastic material. As an example, the lower film PM may be polyethylene terephthalate.

The support plate SK may be disposed under the display panel DP. A portion of the support plate SK may be bent to absorb impacts applied to components between components disposed above the support plate SK and the housing HAU. In addition, the support plate SK may prevent foreign substances from entering the components disposed above the support plate SK.

The lower plate MP may be disposed under the support plate SK. The lower plate MP may be provided with a plurality of holes HL defined therethrough and overlapping the folding area to allow the electronic device ED to be easily folded. The lower plate MP may include a metal material. As an example, the lower plate MP may include one of aluminum (Al) and molybdenum (Mo), however, it should not be limited thereto or thereby. According to an embodiment, the lower plate MP may include a matrix containing fillers and fiber lines that are woven and disposed within the matrix.

The fiber lines may include a reinforced fiber composite. The reinforced fiber composite may be one of a carbon fiber-reinforced plastic (CFRP) and a glass fiber-reinforced plastic (GFRP). A single strand fiber included in one fiber line may have a diameter equal to or greater than about 3 μm and equal to or smaller than about 10 μm.

The matrix may include at least one of epoxy, polyester, polyamide, polycarbonate, polypropylene, polybutylene, and vinyl ester.

The matrix may include the filler. The filler may include at least one of silica, barium sulphate, sintered talc, barium titanate, titanium oxide, clay, alumina, mica, boehmite, zinc borate, and zinc stannate.

Although not shown in figures, the electronic device ED may further include at least one of a cushion layer or a shielding layer. The cushion layer may prevent the lower plate MP from being pressed and deformed by external impact and force. The cushion layer may include a sponge, a foam, or an elastomer such as a urethane resin. In addition, the cushion layer may include at least one of an acrylic-based polymer, a urethane-based polymer, a silicon-based polymer, and an imide-based polymer, however, it should not be limited thereto or thereby. The electronic device ED may be an electromagnetic shielding layer or a heat dissipation layer.

The electronic device ED may further include first, second, third, fourth, fifth, and sixth adhesive layers AD1, AD2, AD3, AD4, AD5, and AD6. The first adhesive layer AD1 may be disposed between the window glass WG and the protective layer PF. The second adhesive layer AD2 may be disposed between the optical layer RPL and the window glass WG. The third adhesive layer AD3 may be disposed between the display module DM and the optical layer RPL. The fourth adhesive layer AD4 may be disposed between the lower film PM and the display module DM. The fifth adhesive layer AD5 may be disposed between the support plate SK and the lower film PM. The sixth adhesive layer AD6 may be disposed between the lower plate MP and the support plate SK.

The first to sixth adhesive layers AD1 to AD6 and adhesive layers described later may include a conventional adhesive, such as a pressure sensitive adhesive (PSA), an optically clear adhesive (OCA), an optical clear resin (OCR), or the like, but it should not be particularly limited. According to an embodiment, at least one of the first to sixth adhesive layers ADI to AD6 may be omitted.

FIG. 4 is a cross-sectional view of the display module DM taken along line I-I′ of FIG. 3.

Referring to FIG. 4, the display module DM may include the display panel DP and an input sensing layer ISP disposed on the display panel DP.

The display panel DP may have a configuration that substantially generates the image. The display panel DP may be a light-emitting type display panel. For example, the display panel DP may be an organic light emitting display panel, an inorganic light emitting display panel, a micro-LED display panel, a micro-OLED display panel, or a nano-LED display layer.

The display panel DP may include a base layer BS, a circuit element layer DP-CL, a display element layer DP-EL, and an encapsulation layer TFE, which are sequentially stacked.

The base layer BS may provide a base surface on which the circuit element layer DP-CL is disposed. The base layer BS may be a flexible substrate that is bendable, foldable, or rollable. The base layer BS may be a glass substrate, a metal substrate, or a polymer substrate, however, it should not be limited thereto or thereby. According to an embodiment, the base layer BS may be an inorganic layer, an organic layer, or a composite material layer.

The base layer BS may have a single-layer or multi-layer structure. For instance, the base layer BS may include a first synthetic resin layer, an inorganic layer having a single-layer or multi-layer structure, and a second synthetic resin layer disposed on the inorganic layer having the single-layer or multi-layer structure. Each of the first and second synthetic resin layers may include a polyimide-based resin. In addition, each of the first and second synthetic resin layers may include at least one of an acrylic-based resin, a methacrylic-based resin, a polyisoprene-based resin, a vinyl-based resin, an epoxy-based resin, a urethane-based resin, a cellulose-based resin, a siloxane-based resin, a polyamide-based resin, and a perylene-based resin. Meanwhile, in the present disclosure, the term “X-based resin”, as used herein, refers to the resin that includes a functional group of X.

The circuit element layer DP-CL may be disposed on the base layer BS. The circuit element layer DP-CL may include an insulating layer, a semiconductor pattern, a conductive pattern, and a signal line. The display element layer DP-EL may be disposed on the circuit element layer DP-CL. The display element layer DP-EL may include a light emitting element (not shown). As an example, the light emitting element may include an organic light emitting material, an inorganic light emitting material, an organic-inorganic light emitting material, a quantum dot, a quantum rod, a micro-LED, or a nano-LED.

The encapsulation layer TFE may be disposed on the display element layer DP-EL. The encapsulation layer TFE may protect the display element layer DP-EL from moisture, oxygen, and a foreign substance such as dust particles. The encapsulation layer TFE may include at least one inorganic layer. As an example, the encapsulation layer TFE may include an inorganic layer, an organic layer, and an inorganic layer, which are sequentially stacked.

The input sensing layer ISP may be disposed on the display panel DP. The input sensing layer ISP may be disposed directly on the encapsulation layer TFE, however, the present disclosure should not be limited thereto or thereby. According to an embodiment, an adhesive member may be disposed between the input sensing layer ISP and the display panel DP.

In the present disclosure, the expression “one component is disposed directly on another component” means that no third component is disposed between the component and the other component. For example, when one component is “directly disposed” on another component, it means that the component and the other component are “contact” each other.

The input sensing layer ISP may sense an external input, may convert the sensed input to a predetermined input signal, and may provide the input signal to the display panel DP. As an example, the input sensing layer ISP may be a touch sensing layer that senses a touch event. The input sensing layer ISP may sense a direct touch of the user, an indirect touch of the user, a direct touch of an object, or an indirect touch of an object.

The input sensing layer ISP may sense at least one of a position of a touch event applied from the outside and an intensity (pressure) of the touch event applied from the outside. The input sensing layer ISP may have various structures or may include various materials, but it should not be limited thereto or thereby. As an example, the input sensing layer ISP may sense the external input in a capacitive manner. The display panel DP may receive the input signal from the input sensing layer ISP and may generate the image corresponding to the input signal.

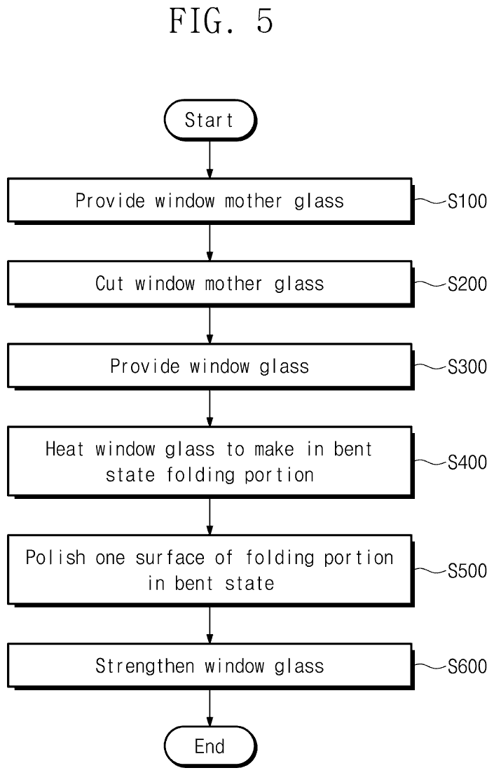

FIG. 5 is a flowchart illustrating a method of manufacturing the window glass according to an embodiment of the present disclosure.

The manufacturing method of the window glass may include providing the window glass including the folding portion and the non-folding portions spaced apart from each other with the folding portion interposed therebetween (S300), heating the window glass to make the folding portion to be in a bent state (S400), and polishing one surface of the folding portion in the bent state (S500).

In addition, the manufacturing method of the window glass may further include providing a mother glass (hereinafter, referred to as window mother glass) from which the window glass is cut (S100) and cutting the window mother glass (S200) before the providing of the window glass (S300).

In addition, the manufacturing method of the window glass may further include strengthening the window glass (S600) after the polishing of the one surface of the folding portion (S500). The strengthening of the window glass (S600) may include a chemical strengthening process in which first ions in the polished window glass are replaced with second ions that are different from the first ions.

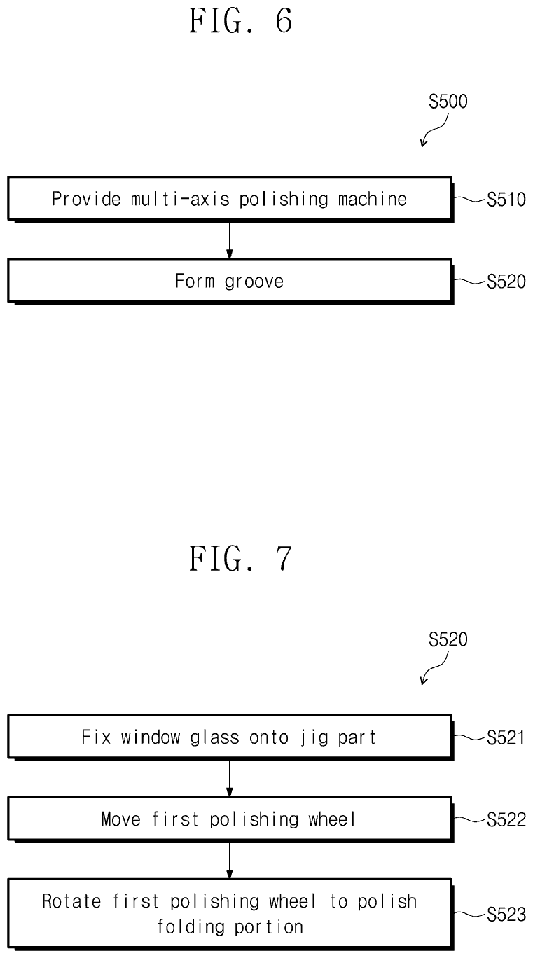

FIG. 6 is a flowchart illustrating processes of the method of manufacturing the window glass according to an embodiment of the present disclosure.

Referring to FIG. 6, the polishing of the one surface of the folding portion in the bent state (S500) may include providing a multi-axis polishing machine (S510) and forming a groove in the folding portion using the multi-axis polishing machine (S520).

FIG. 7 is a flowchart illustrating processes of the method of manufacturing the window glass according to an embodiment of the present disclosure.

Referring to FIG. 7, the forming of the groove in the folding portion (S520) may include fixing the window glass onto a jig part (S521), moving a first polishing wheel in a direction toward the folding portion to be in contact with the folding portion (S522), and rotating the first polishing wheel to polish the one surface of the folding portion (S523).

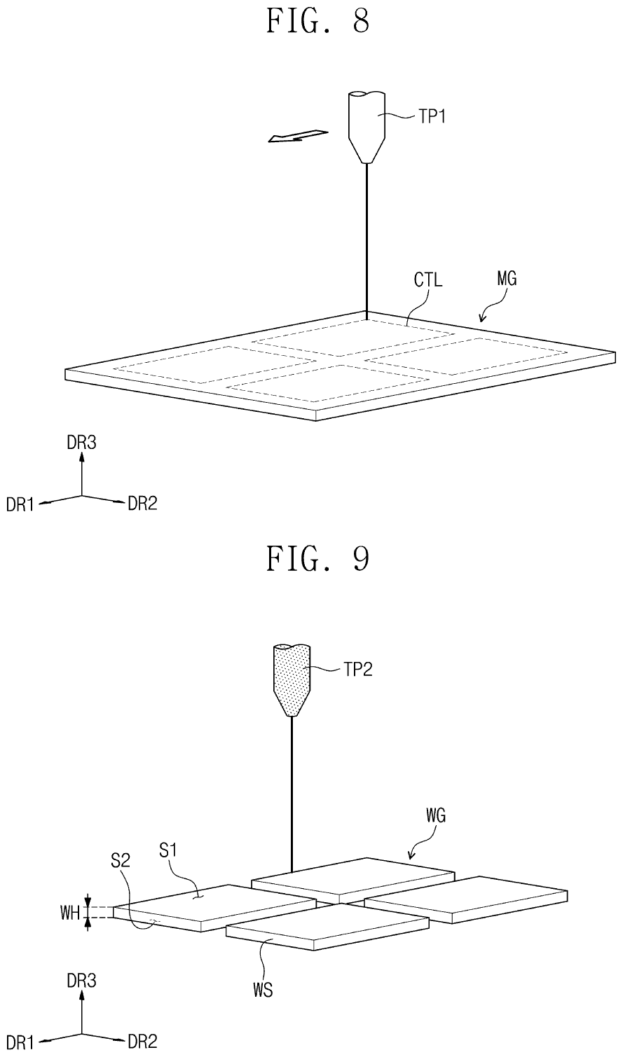

FIGS. 8 to 16 are views illustrating processes of the method of manufacturing the window glass according to an embodiment of the present disclosure.

Hereinafter, each process of the manufacturing method of the window glass will be described with reference to FIGS. 8 to 16.

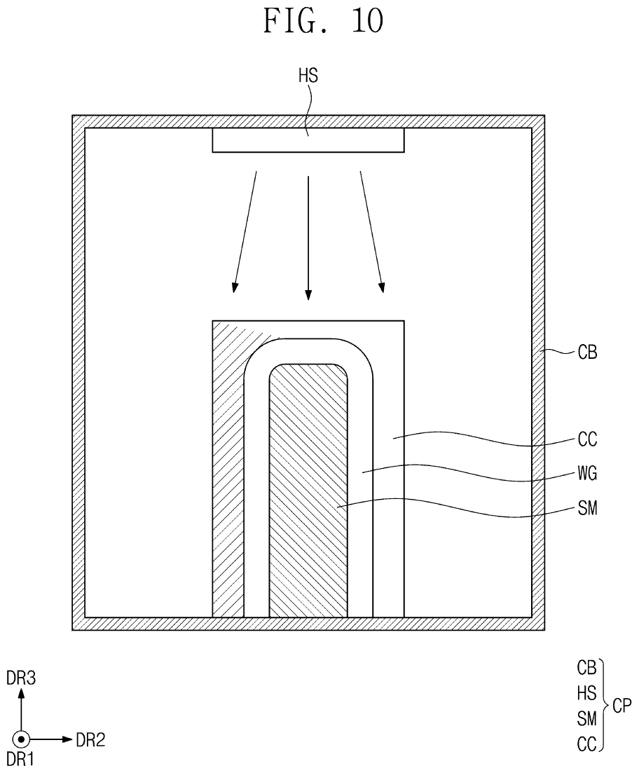

Referring to FIGS. 8 and 9, the providing of the window mother glass (S100, refer to FIG. 5) and the cutting of the window mother glass (S200, refer to FIG. 5) may be performed.

FIG. 8 shows the process of cutting the window mother glass MG using a first polishing tool TP1. The first polishing tool TP1 shown in FIG. 8 may be a laser cutter, however, the present disclosure should not be limited thereto or thereby. According to an embodiment, the window mother glass may be cut by other processes such as a scribing process, a waterjet process, etc.

In the present embodiment, the laser cutter TP1 may irradiate a laser beam along a cutting line CTL to cut the window mother glass MG.

FIG. 9 shows four window glasses WG manufactured by cutting one window mother glass MG as a representative example, however, the number of window glasses WG manufactured by cutting the window mother glass MG should not be particularly limited.

A cut surface WS of the cut window mother glass MG may be processed by a computer numerical control (CNC) process. The cut surface WS of the window mother glass MG may be referred to as a “side surface of the window glass WG”. That is, the side surfaces WS of the window glass WG may be processed by the computer numerical control (CNC) process, and a surface quality of the side surfaces WS of the window glass WG may be improved.

The window glass WG may have a thickness WH equal to or greater than about 0.05 mm and equal to or smaller than about 0.6 mm. In the present embodiment, the window glass WG may be an ultra-thin glass (UTG).

One surface of the window glass WG may be processed by a polishing process described later, and the one surface of the window glass WG may be a first surface S1 or a second surface S2 facing the first surface S1 of the window glass WG.

Then, referring to FIG. 10, the heating and thermal forming process of the window glass S400 (refer to FIG. 5) may be performed.

The thermal forming process S400 (refer to FIG. 5) may include bending the window glass WG to have a predetermined curvature and heating the window glass WG in the bent state.

In the thermal forming process S400 (refer to FIG. 5), the window glass WG may be bent, and the bent window glass WG may be heated, thereby changing a basic shape of the window glass WG.

The window glass WG before being subjected to the thermal forming process may have a flat shape as its basic shape, however, the window glass WG after being subjected to the thermal forming process S400 (refer to FIG. 5) may have a bent shape as its basic shape.

When external force is applied to a flat window glass to maintain its bent shape, internal stress may develop in the window glass WG. However, when the window glass WG is formed in the bent state, the internal stress that occurs from maintaining its bent state may be relieved.

FIG. 10 shows the process of bending of the window glass WG using a curvature forming device CP.

The curvature forming device CP may include a chamber CB, a press part CC placed in the chamber, a heat source HS, and a support part SM. The support part SM may have an upward convex shape. The press part CC may move in a downward direction to bend the window glass WG to correspond to a shape of the support part SM. The window glass WG in the bent state may be heated by the heat source HS. The bent window glass WG may be subjected to an annealing process. Thus, the internal stress of the window glass WG in the bent state may be relieved, and a structure of the material may be stabilized.

In the present embodiment, the window glass WG may be heated at a temperature equal to or greater than about 500° C. and equal to or smaller than about 750° C. In detail, the window glass WG may be heated at a temperature equal to or greater than about 620° C. and equal to or smaller than about 720° C.

In the present embodiment, the window glass WG may be heated for a time equal to or longer than about 10 seconds and equal to or shorter than about 120 seconds in the thermal forming process (S400).

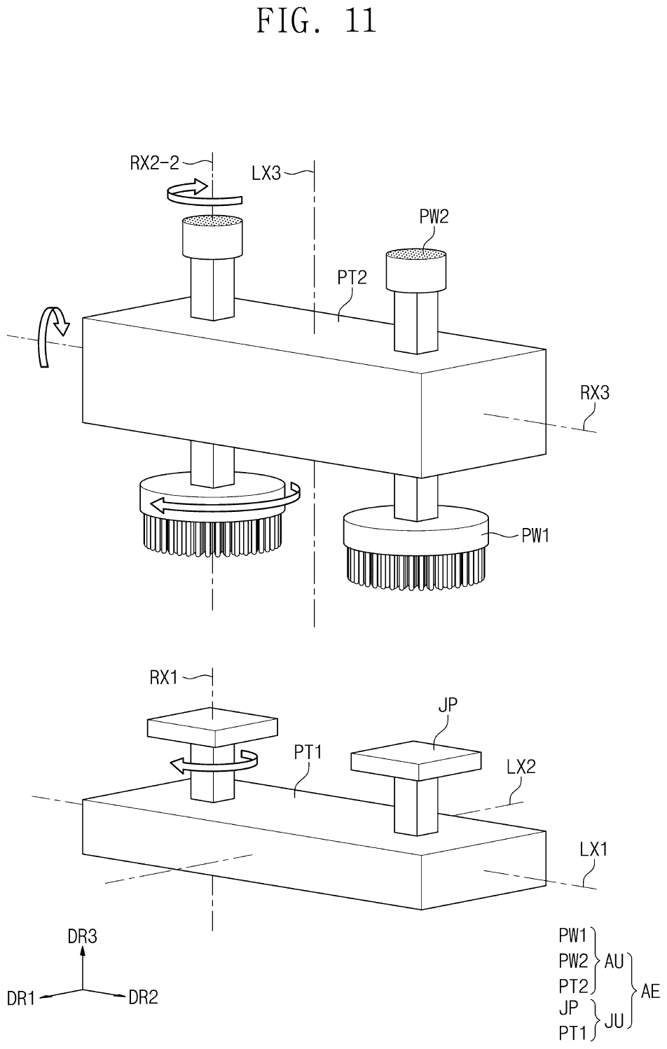

Referring to FIG. 11, the multi-axis polishing machine AE may be provided to polish the window glass WG.

The multi-axis polishing machine AE may be a 5-axis polishing machine. The multi-axis polishing machine AE may perform precise polishing process by moving a polishing position in the first to third directions DR1 to DR3 based on a target to be polished or by rotating in two or more directions.

In the present embodiment, the multi-axis polishing machine AE may include a jig unit JU and a polishing unit AU.

The jig unit JU may be a component onto which the window glass WG is placed and fixed to be polished. The jig unit JU may move in the first direction DR1 and the second direction DR2. FIG. 11 shows that the jig unit JU moves along a first axis LX1 and a second axis LX2, which are substantially parallel to the second direction DR2 and the first direction DR1, respectively, in dotted lines.

The jig unit JU may include a first plate PT1 and the jig part JP disposed on the first plate PT1.

In the present embodiment, the jig part JP may have a plate shape. The jig part JP may provide a base surface on which the window glass WG (refer to FIG. 9) is disposed. Although not shown in figures, the jig part JP may have a vacuum suction hole defined therein and may fix the window glass WG (refer to FIG. 9) disposed thereon. However, the present disclosure should not be limited thereto or thereby, and the jig part JP should not be particularly limited as long as the jig part JP may fix and may rotate the bent window glass WG (refer to FIG. 9). As an example, the jig part JP may be provided in the form of a clamp to fix the bent window glass WG (refer to FIG. 9).

The jig part JP may rotate in one direction. In the present embodiment, the jig part JP may rotate around to a first rotation axis RX1 substantially parallel to the third direction DR3. When the jig part JP rotates, the window glass WG (refer to FIG. 9) disposed on the jig part JP may also rotate.

FIG. 11 shows two jig parts JP as a representative example, however, the number of the jig parts JP used in a single process should not be limited to two.

The polishing unit AU may include a second plate PT2 and polishing wheels PW1 and PW2 disposed on the second plate PT2. The polishing unit AU may be a member that substantially polishes the window glass WG (refer to FIG. 9).

The polishing unit AU may move in the third direction DR3. FIG. 11 shows that the polishing unit AU may move along a third axis LX3 parallel to the third direction DR3 in a dotted line. The polishing unit AU may move in a direction toward the window glass WG (refer to FIG. 9) disposed on the jig part JP or in a direction away from the window glass WG (refer to FIG. 9).

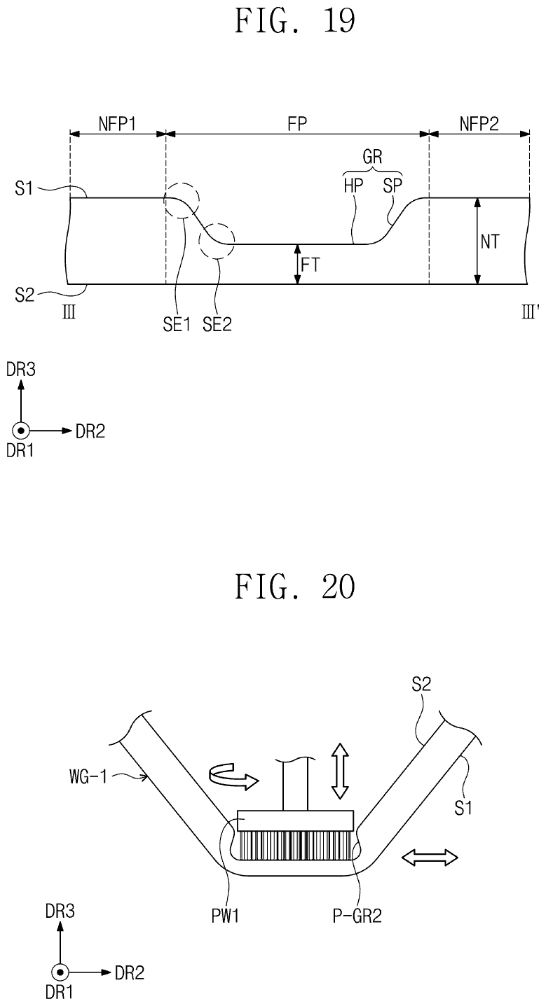

Depending on the movement of the polishing unit AU, the contact between the polishing wheels PW1 and PW2 and the window glass WG (refer to FIG. 9) may be changed. According to an embodiment, a depth of a groove GR (refer to FIG. 19) formed in the window glass WG (refer to FIG. 9) may be finely controlled by adjusting a depth at which the polishing wheels PW1 and PW2 are in contact with the window glass WG (refer to FIG. 9).

The polishing unit AU may rotate around the second direction DR2. FIG. 11 shows a structure in which the polishing unit AU rotates around a third rotation axis RX3 parallel to the second direction DR2 as a representative example.

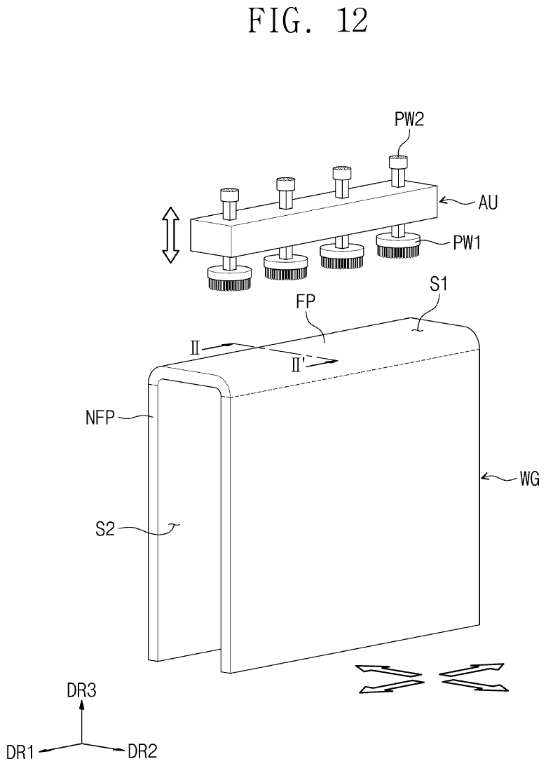

When the polishing unit AU rotates, the type of polishing wheel PW1 or PW2 that comes into contact with the window glass WG may be changed. As an example, when the polishing unit AU moves downward in the state shown in FIG. 11, the first polishing wheel PW1 may be in contact with the window glass WG (refer to FIG. 12), however, when the polishing unit AU rotates 180° around the third rotation axis RX3 and moves downward, the second polishing wheel PW2 may be in contact with the window glass WG (refer to FIG. 12).

The polishing wheels PW1 and PW2 may rotate around one direction to polish the window glass WG. The polishing wheels PW1 and PW2 may be a polishing brush, a polishing sponge, or a polishing pad.

The second plate PT2 may be spaced apart from the first plate PT1 in the third direction DR3. In the present embodiment, the second plate PT2 may include a first surface facing the first plate PT1 and a second surface opposite to the first surface. The first polishing wheel PW1 may be disposed on the first surface, and the second polishing wheel PW2 may be disposed on the second surface. FIG. 11 shows that the polishing brush is provided on one surface of the second plate PT2 as the first polishing wheel PW1 and the polishing pad is provided on a surface opposite to the first polishing wheel PW1 of the second plate PT2 as the second polishing wheel PW2 as a representative example.

The first polishing wheels PW1 may rotate to polish the window glass WG (refer to FIG. 9). The second polishing wheels PW2 may rotate to trim the polished surface of the window glass WG (refer to FIG. 9) more precisely than the first polishing wheels PW1, and thus, the surface quality of the window glass WG (refer to FIG. 9) may be improved.

However, the number and types of the polishing wheels PW1 and PW2 should not be particularly limited as long as the polishing wheels PW1 and PW2 may polish the window glass WG. A different type of polishing wheel may be additionally disposed on the other surface of the second plate PT2. According to an embodiment, the number of each of the polishing wheels PW1 and PW2 provided in the second plate PT2 may be one or three or more.

Hereinafter, the polishing of the one surface of the folding portion in the bent state S500 (refer to FIG. 5) will be described with reference to FIGS. 12 to 17.

In the following descriptions of FIGS. 12 to 17, details of the elements that are the same as those described with reference to FIGS. 7 to 11 will be omitted. In addition, for the convenience of explanation, the jig unit JU fixing the window glass WG is omitted in FIGS. 12 to 17, and four first polishing wheels PW1 and four second polishing wheels PW2 are provided.

Referring to FIG. 12, the window glass WG may include the second surface S2 of which one portion faces another portion in the bent state, and the first surface S1 opposite to the second surface S2.

The forming of the groove in the folding portion S520 (refer to FIG. 7) may include fixing the window glass WG onto the jig part, moving the first polishing wheel in the direction toward the folding portion to be in contact with the folding portion, and rotating the first polishing wheel to polish the one surface of the folding portion.

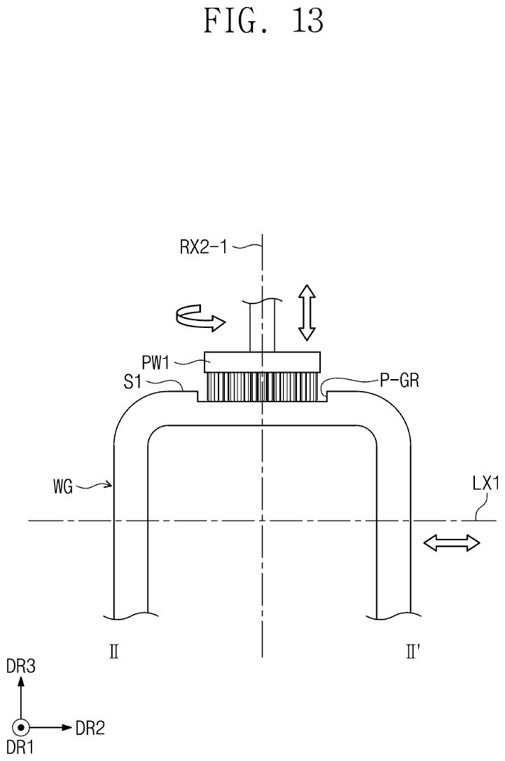

FIG. 13 shows the state in which the first polishing wheel PW1 is in contact with the folding portion after moving in the direction toward the folding portion. FIG. 13 is a cross-sectional view taken along line II-II′ of FIG. 12.

Referring to FIG. 13, the first polishing wheel PW1 may rotate around a second-first rotation axis RX2-1 to form a preliminary-groove P-GR in the first surface S1 of the folding portion FP of the window glass WG. In the present disclosure, the term “preliminary-groove P-GR” may refer to a portion of the window glass WG that is polished but is not yet completed as the groove GR.

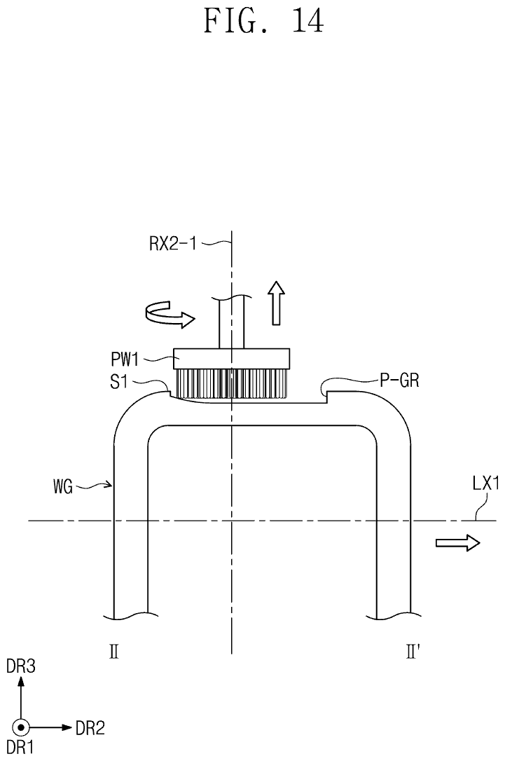

FIG. 14 illustrates the state in which the window glass WG has moved along the second direction DR2 and the first polishing wheel PW1 has moved upward along the third direction DR3.

Referring to FIG. 14, as the window glass WG moves left and right along the second direction DR2, a left-right width of the preliminary-groove P-GR may be adjusted. As an example, when the window glass WG moves to the right along the second direction DR2, the first polishing wheel PW1 may move to the left relative to the window glass WG. Accordingly, the window glass WG may be further polished.

As the first polishing wheel PW1 moves up and down along the third direction DR3, a depth of the preliminary-groove P-GR may be adjusted. As an example, when the first polishing wheel PW1 moves in the upward direction, the depth of the preliminary-groove P-GR may decrease.

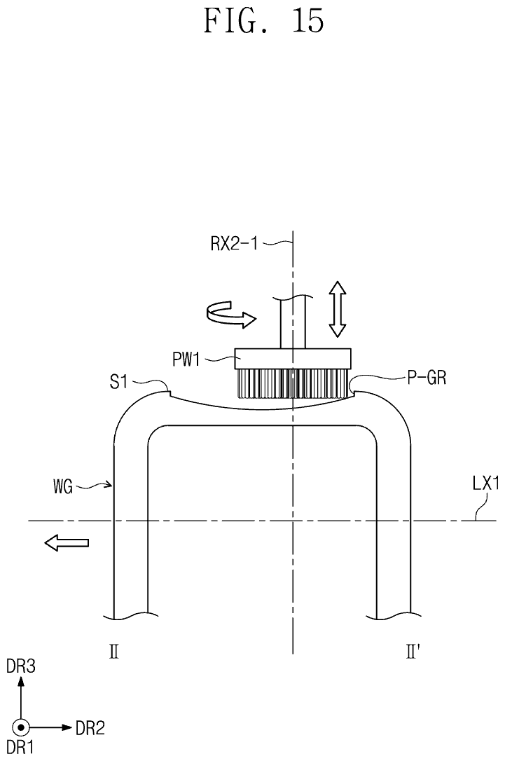

Referring to FIG. 15, the window glass WG may move to the left along the direction opposite to the second direction DR2, and the first polishing wheel PW1 may move upward along the third direction DR3. Accordingly, the preliminary-groove P-GR may be further polished.

As described with reference to FIGS. 13 to 15, since the manufacturing method of the window glass is performed using the multi-axis polishing machine AE (refer to FIG. 11), the shape of the groove GR may be precisely formed. That is, as the multi-axis polishing machine AE may move the window glass WG along the first direction DR1, the second direction DR2, and the third direction DR3 according to the relative movement between the polishing unit AU and the jig unit JU, the etching position and shape of the window glass WG may be precisely adjusted.

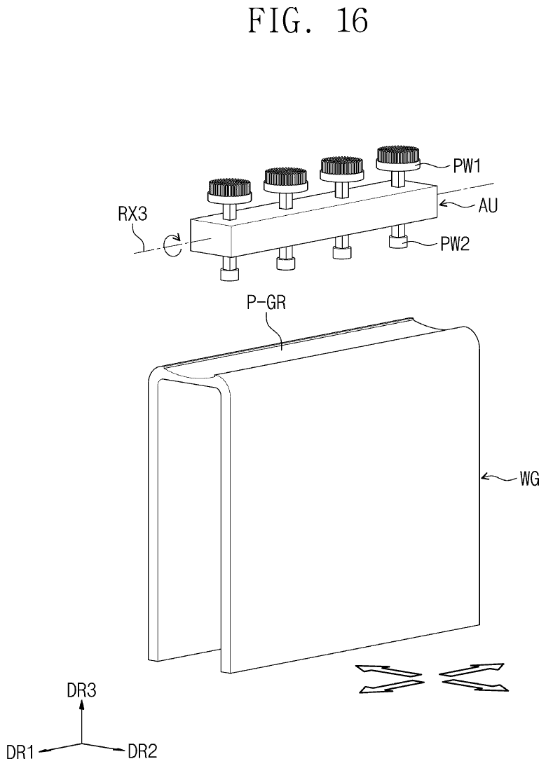

Referring to FIG. 16, the polishing unit AU may rotate around the third rotation axis RX3. The polishing unit AU may rotate about 180° to allow the second polishing wheel PW2 to face the window glass WG.

Then, the polishing unit AU may move in the downward direction to allow the second polishing wheel PW2 to be in contact with the window glass WG, and the second polishing wheel PW2 may rotate to further polish the groove GR.

The forming of the groove in the folding portion S520 (refer to FIG. 7) may further include providing the second polishing wheel PW2 in the direction toward the folding portion, moving the second polishing wheel to the direction toward the folding portion to allow the second polishing wheel to be in contact with the folding portion, and rotating the second polishing wheel to polish the one surface of the folding portion.

The descriptions on the movement of the first polishing wheel PW1 with reference to FIGS. 13 to 15 may be applied equally to the movement of the second polishing wheel PW2, and thus, descriptions on the movement of the second polishing wheel PW2 will not be repeated.

Then, the chemical strengthening process S600 (refer to FIG. 5) may be performed. Although not shown in figures, the chemical strengthening process S600 (refer to FIG. 5) may include replacing the ions included in the window glass WG with other ions. For instance, when the window glass WG containing glass is immersed in high-temperature molten alkali salt, some of sodium ions (Na+) on the surface of window glass WG may be replaced with potassium ions (K+). Since potassium ion (K+) is larger than sodium ion (Na+) and forms a compressive stress layer when being cooled, the strength of the window glass WG may increase.

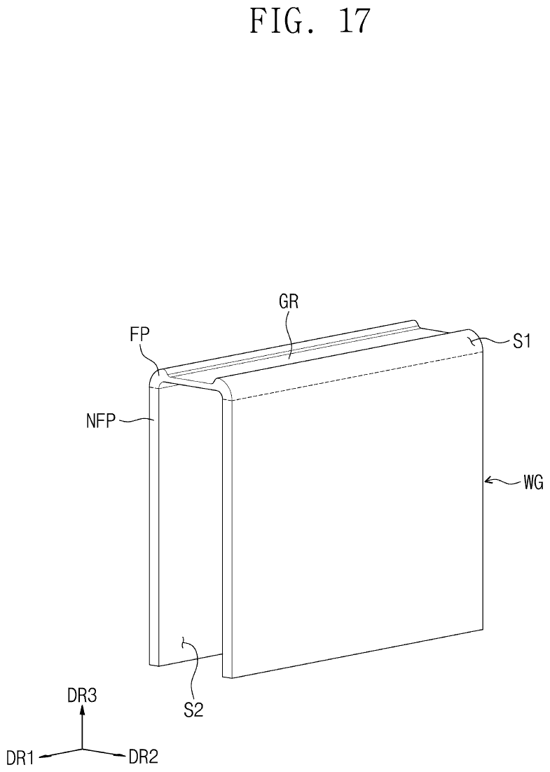

Hereinafter, characteristics of the window glass WG manufactured by the method of manufacturing the window glass according to the present disclosure will be described with reference to FIGS. 17 to 19.

FIG. 17 shows the window glass WG in the bent state. Since the thermal forming process is performed on the window glass WG manufactured by the manufacturing method of the window glass of the present disclosure, the window glass WG may have the bent shape as its basic shape. That is, the window glass WG may maintain the bent state without the application of the external force, however, the present disclosure should not be limited thereto or thereby. According to an embodiment, the window glass WG may have the flat shape as its basic shape, but the window glass WG may have reduced internal stress when in the bent state.

In the bent state, planes including portions of the second surface S2 of non-folding portions NFP, which face each other, may form a predetermined angle. In the present disclosure, the angle may be referred to as an angle of the non-folding portions in the bent state. In the present embodiment, the portions of the second surface S2 of the non-folding portions NFP facing each other may be substantially parallel to each other, however, the present disclosure should not be limited thereto or thereby. As another example, the angle of the non-folding portions in the bent state may be equal to or smaller than about 90 degrees.

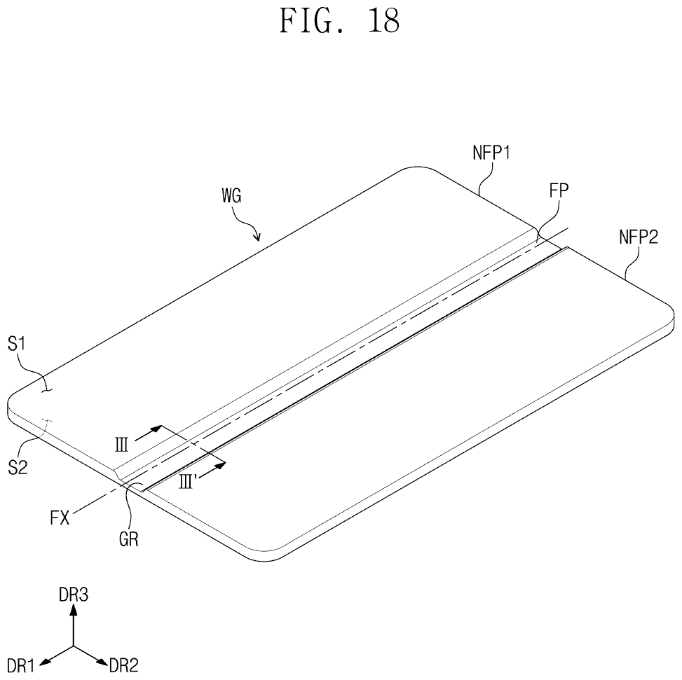

FIG. 18 is a perspective view of the window glass according to an embodiment of the present disclosure. FIG. 19 is a cross-sectional view taken along line III-III′ of FIG. 18. FIG. 18 shows the window glass WG in the unfolded state.

Referring to FIGS. 18 and 19, the window glass manufactured by the manufacturing method of the window glass may include the folding portion FP and non-folding portions NFP1 and NFP2 spaced apart from each other with the folding portion FP interposed therebetween.

After the polishing process (S500) is performed, the folding portion FP may have a thickness FT smaller than the thickness WH (refer to FIG. 9) of the window glass. The thickness FT of the folding portion FP may be smaller than a thickness NT of the non-folding portion NFP1 and NFP2. As an example, the thickness NT of the non-folding portion may be equal to or greater than about 0.05 mm and equal to or smaller than about 0.6 mm. The thickness FT of the folding portion FP may be equal to or greater than about 0.03 mm and equal to or smaller than about 0.1 mm.

The groove GR may be defined in the folding portion FP of the window glass WG. The groove GR may be formed in the forming of the groove S520 (refer to FIG. 6). In the present embodiment, the groove GR may be formed by recessing a portion of the first surface S1 of the window glass WG in the thickness direction, however, the present disclosure should not be limited thereto or thereby. According to an embodiment, the groove GR may be formed in the window glass by recessing a portion of the second surface S2 in the thickness direction or by recessing a portion of both the first surface S1 and the second surface S2.

In the present embodiment, the groove GR may be defined by a flat portion HP and slant portions SP spaced apart from each other with the flat portion HP interposed therebetween and slant to the flat portion HP from a boundary between the groove GR and the non-folding portion NFP.

In the present embodiment, one end SE1 and the other end SE2 of each of the slant portions SP may have a predetermined curvature when viewed in a cross-section.

FIG. 19 shows the structure in which the one end SEI of the slant portions, which corresponds to the boundary between the groove GR and the non-folding portions NFP1 and NFP2, has the predetermined curvature and the other end SE2 of the slant portions, which corresponds to a boundary between the flat portion HP and the slant portions SP1 and SP2, has the predetermined curvature.

According to the manufacturing method of the window glass, since the window glass WG is polished by the multi-axis polishing machine AE (refer to FIG. 11), the boundary portions SE1 and SE2 and portions around the boundary portions SE1 and SE2 may be formed into a gently curved surface. That is, the boundary between the groove GR and the non-folding portions NFP1 and NFP2 and the boundary between the flat portion HP and the slant portions SP may be formed in the gently curved surface.

According to the present embodiment, as the portions adjacent to the folding portion FP are formed more gently, the stress applied between the folding portion FP and the slant portions SP

during the folding operation may be reduced. Accordingly, the folding characteristics of the window glass may be improved.

According to the present embodiment, the method of manufacturing the window glass WG, which is ultra-thin glass UTG, with reduced bending stress in the bent state may be provided.

FIG. 20 is a view illustrating processes of a method of manufacturing a window glass WG-1 according to an embodiment of the present disclosure.

A process of the manufacturing method of the window glass shown in FIG. 20 may correspond to the polishing of the one surface of the folding portion in the bent state S500 (refer to FIG. 5). In FIG. 20, the same/similar reference numerals denote the same/similar elements in FIGS. 5 to 19, and thus, detailed descriptions of the same/similar elements will be omitted.

Referring to FIG. 20, a second surface S2 in the bent window glass WG-1 is disposed to face a direction towards which the third direction DR3 is oriented. That is, different from the window glass WG described with reference to FIGS. 13 to 15, the second surface S2 may face a first polishing wheel PW1. Accordingly, a preliminary-groove P-GR2 may be formed by polishing the second surface S2 in a thickness direction of the window glass WG-1.

According to the manufacturing method of the window glass of the present disclosure, a shape and a mounting configuration of a window to be manufactured may be adjusted in a thermal forming stage or a window glass processing stage, and thus, a shape of the groove formed in the folding portion may be easily controlled.

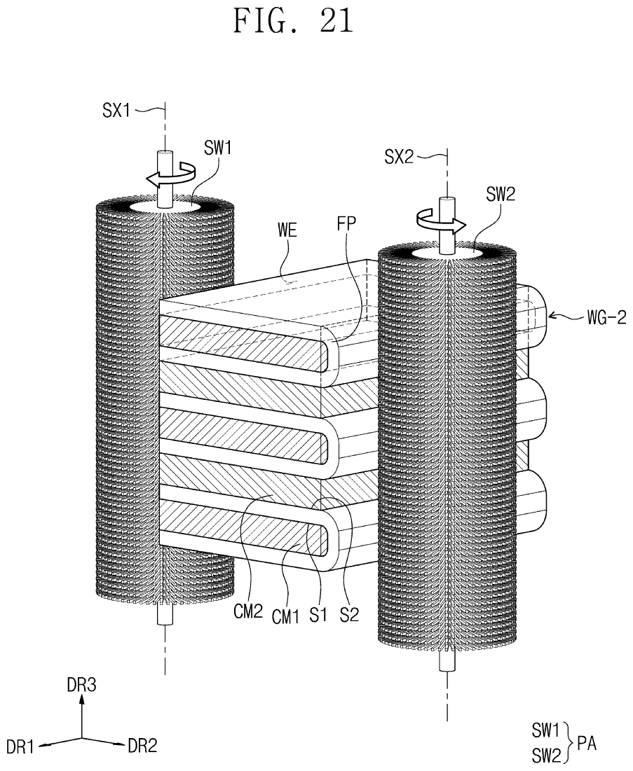

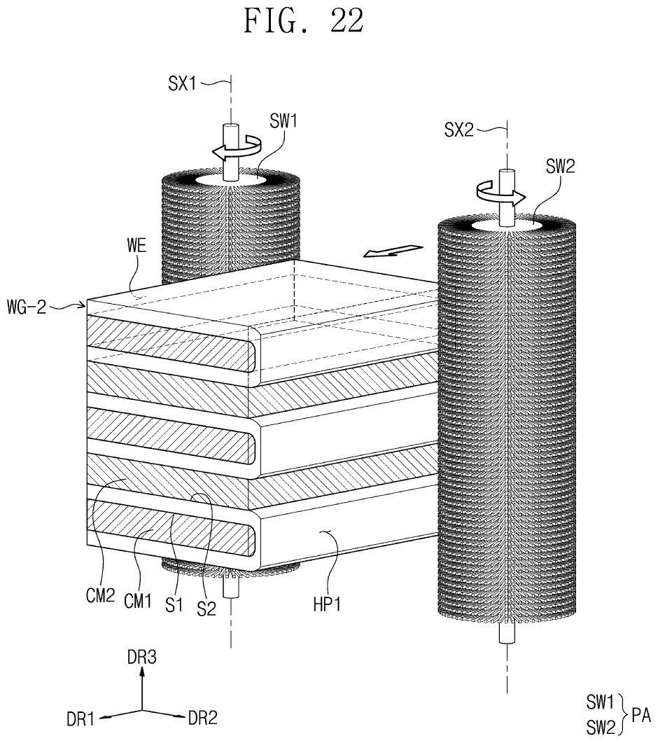

FIGS. 21 and 22 are views illustrating processes of a method of manufacturing a window glass WG-2 according to an embodiment of the present disclosure.

In FIGS. 21 and 22, the same/similar reference numerals denote the same/similar elements in FIGS. 5 to 19, and thus, detailed descriptions of the same/similar elements will be omitted.

The manufacturing method of the window glass may include providing a window mother glass S100 (refer to FIG. 5), cutting the window mother glass S200 (refer to FIG. 5), providing a window glass S300 (refer to FIG. 5), heating and thermal forming the window S400 (refer to FIG. 5), polishing one surface of a folding portion in a bent state S500 (refer to FIG. 5), and strengthening the window S600 (refer to FIG. 5).

The window glass WG-2 may be manufactured by performing the providing of the window mother glass S100 (refer to FIG. 5), the cutting of the window mother glass S200 (refer to FIG. 5), the providing of the window S300 (refer to FIG. 5), and the heating and thermal forming of the window S400 (refer to FIG. 5). That is, the window glass WG-2 in the bent state may be obtained by performing the heating and thermal forming S400.

In the present embodiment, the window glass WG-2 may be provided in plural. When the window glass WG-2 is provided in plural, the window glasses WG-2 may be stacked to perform the polishing process simultaneously, and thus, a process efficiency may be improved. FIG. 21 shows three window glasses WG-2 as a representative example, however, the present disclosure should not be limited thereto or thereby. As another example, the window glass WG-2 may be provided as a single unit.

The manufacturing method of the window glass may further include alternately stacking the window glasses WG-2 bent through the thermal forming process with second impact absorbing members CM2 therebetween after the heating and thermal forming process of the window glasses S400.

The impact absorbing members CM1 and CM2 may be provided between surfaces of the stacked window glasses WG-2.

The impact absorbing members CM1 and CM2 may prevent impacts from occurring between the window glasses WG-2 and scratches from occurring on the surfaces of the window glasses WG-2. The impact absorbing members CM1 and CM2 may be a sponge, an interleaving paper for glass, etc.

A first impact absorbing member CM1 may be disposed between surfaces facing each other in each of the stacked window glasses WG-2 in the bent state, and the second impact absorbing member CM2 may be disposed between surfaces of different stacked window glasses WG-2 facing each other. FIG. 21 shows the structure in which the first impact absorbing member CM1 is disposed between first surfaces S1 and the second impact absorbing member CM2 is disposed between the second surfaces S2 facing each other and respectively included in different window glasses WG-2 as a representative example.

In the present embodiment, the manufacturing method of the window glasses WG-2 may be performed by a side polishing machine. That is, different from the manufacturing method of the window glasses WG-2 described with reference to FIGS. 7 to 19, the polishing process may be performed using the side polishing machine instead of the multi-axis polishing machine.

Referring to FIG. 21, the polishing machine PA may be provided. The polishing machine PA may include a first side polishing wheel SW1 and a second side polishing wheel SW2.

The first and second side polishing wheels SW1 and SW2 may be a polishing wheel. Each of the side polishing wheels SW1 and SW2 may rotate. The first side polishing wheel SW1 may rotate around a first side rotation axis SX1, and the second side polishing wheel SW2 may rotate around a second side rotation axis SX2. In the present embodiment, the first and second side rotation axes SX1 and SX2 may be substantially parallel to the third direction DR3.

The first side polishing wheels SW1 may be adjacent to an edge WE of the window glass WG-2, and the second side polishing wheels SW2 may be adjacent to a folding portion FP of the window glass WG-2. That is, different from the processes described with reference to FIGS. 12 to 15, since the polishing wheels are also provided adjacent to the edges WE of the window glasses WG-2, not only the folding portions FP of the window glasses WG-2 but also the edges WE may be substantially simultaneously polished.

When viewed in the third direction DR3, a rotation direction of the first side polishing wheel SW1 may be opposite to a rotation direction of the second side polishing wheel SW2. Referring to FIG. 21, when viewed in the third direction DR3, the first side polishing wheel SW1 may rotate in a clockwise direction, and the second side polishing wheel SW2 may rotate in a counter-clockwise direction, however, the present disclosure should not be limited thereto or thereby. According to an embodiment, the first side polishing wheel SW1 may rotate in the counter-clockwise direction, and the second side polishing wheel SW2 may rotate in the clockwise direction.

Referring to FIG. 22, the stacked window glasses WG-2 and the impact absorbing members CM1 and CM2 may move along the first direction DR1.

The window glasses WG-2 may be simultaneously in contact with the first side polishing wheel SW1 and the second side polishing wheel SW2. The stacked window glasses WG-2 may move between the first side polishing wheel SW1 and the second side polishing wheels SW2. As shown in FIG. 22, the first side polishing wheel SW1 may rotate in the clockwise direction, the second side polishing wheel SW2 may rotate in the counter-clockwise direction, and the stacked window glasses WG-2 may move in the first direction DR1.

The side polishing process may include rotating the first side polishing wheel SW1 to polish the edges WE and rotating the second side polishing wheel to polish the folding portion FP of the window glass WG-2.

In the present embodiment, the edges WE and the folding portions FP of the window glasses WG-2 may be polished. The polishing of the edges WE and the polishing of the folding portions FP may be substantially simultaneously performed. Accordingly, a surface quality of the edges WE of the window glasses WG-2 may be improved, and simultaneously, a flat portion HP1 of the folding portion FP may be formed. In this process, the edges WE and the folding portions FP may be referred to as “side surfaces” of the window glasses WG-2.

According to the manufacturing method of the window glass of the present embodiment, only the flat portion HP1 may be formed in the folding portion FP, and the slant portions SP (refer to FIG. 19) may not be formed. However, since each of the window glasses WG-2 is bent to allow two surfaces facing each other to be substantially parallel to each other, a groove (refer to GR of FIG. 19) having a uniform curvature may be formed when the window is unfolded after the folding portion FP of the window glass WG-2 is polished. Accordingly, the flat portion HP1 may have a gently curved surface. Therefore, the internal stress occurring when the window glasses WG-2 are folded or unfolded may be reduced.

As the manufacturing method of the window glass includes the bending and thermal forming of the window glasses WG-2 before the folding portion FP and the edges WE are polished, the window glasses may be substantially simultaneously etched after being stacked one on another. Thus, the manufacturing method of the window glass may be simplified, and a manufacturing cost may be reduced.

In addition, according to the manufacturing method of the window glass, not only the folding portions FP but also the edges WE of the window glasses WG-2 may be simultaneously processed, and thus, the surface quality of the edges WE may be improved.

Although the embodiments of the present disclosure have been described, it is understood that the present disclosure should not be limited to these embodiments but various changes and modifications can be made by one ordinary skilled in the art within the spirit and scope of the present disclosure as hereinafter claimed. Therefore, the disclosed subject matter should not be limited to any single embodiment described herein, and the scope of the present invention shall be determined according to the attached claims.

What is claimed is:

1. A method of manufacturing a window glass, comprising:
providing a window glass comprising a folding portion and non-folding portions spaced apart from each other with the folding portion interposed therebetween;
heating the window glass to make the folding portion in a bent state; and
polishing one surface of the folding portion in the bent state.

2. The method of claim 1, wherein the window glass comprises a glass material, and the folding portion is heated at a temperature equal to or greater than about 500° C. and equal to or smaller than about 750° C. in the heating of the window glass.

3. The method of claim 1, wherein the window glass is heated for a time equal to or longer than about 10 seconds and equal to or shorter than about 120 seconds in the heating of the window glass.

4. The method of claim 1, wherein the polishing of the one surface of the folding portion comprises:
providing a multi-axis polishing machine; and
forming a groove in the folding portion using the multi-axis polishing machine.

5. The method of claim 4, wherein the multi-axis polishing machine comprises:
a jig unit comprising a first plate, which moves in first and second directions intersecting with each other in a plan view, and a jig part disposed on the first plate and rotatable; and
a polishing unit comprising a second plate spaced apart from the first plate in a third direction intersecting the first and second directions and comprising a first surface facing the first plate and a second surface opposite to the first surface, a first polishing wheel disposed on the first surface and rotatable, and a second polishing wheel disposed on the second surface and rotatable, and
the forming of the groove comprises:
fixing the window glass onto the jig part;
moving the first polishing wheel in a direction toward the folding portion to allow the first polishing wheel to be in contact with the folding portion; and
rotating the first polishing wheel to polish the one surface of the folding portion.

6. The method of claim 5, wherein the forming of the groove further comprises:
providing the second polishing wheel in the direction toward the folding portion;
moving the second polishing wheel in the direction toward the folding portion to allow the second polishing wheel to be in contact with the folding portion; and
rotating the second polishing wheel to polish the one surface of the folding portion.

7. The method of claim 6, wherein each of the first and second polishing wheels comprises a polishing brush or a polishing pad.

8. The method of claim 4, wherein the folding portion comprises a flat portion and slant portions spaced apart from each other with the flat portion interposed therebetween and slant to the flat portion from the non-folding portions, which are formed by the forming of the groove.

9. The method of claim 8, wherein a first end and a second end of each of the slant portions have a predetermined curvature in a cross-sectional view, the first end is adjacent to a corresponding one of the non-folding portions, and the second end is adjacent to the flat portion.

10. The method of claim 1, wherein the one surface of the folding portion extends from first surfaces of the non-folding portions, which face each other in the bent state, or second surfaces of the non-folding portions opposite to the first surfaces.

11. The method of claim 1, wherein the window glass has a thickness equal to or greater than about 0.05 millimeters (mm) and equal to or smaller than about 0.6 mm in the providing of the window glass.

12. The method of claim 1, wherein, after the polishing of the one surface of the folding portion, the folding portion has a thickness equal to or greater than about 0.03 mm and equal to or smaller than about 0.1 mm, and the thickness of the folding portion is smaller than a thickness of each of the non-folding portions.

13. The method of claim 1, further comprising, before the providing of the window glass:
providing a window mother glass; and
cutting the window mother glass.

14. The method of claim 13, wherein the cutting of the window mother glass comprises:
performing one of a scribing process, a waterjet process, and a laser cutting process on the window mother glass to cut the window mother glass; and
processing a cut surface of the cut window mother glass using a computer numerical control process.

15. The method of claim 1, wherein, in the bent state, an angle between portions of a surface of the non-folding portions facing each other is equal to or smaller than about 90 degrees.

16. The method of claim 1, wherein a first impact absorbing member is disposed between the non-folding portions.

17. The method of claim 1, wherein the window glass is provided in plural,
the method further comprises a stacking process after the heating of the window glass and before the polishing of the one surface, and
in the staking process, the plurality of window glasses are alternately stacked with second impact absorbing members therebetween.

18. The method of claim 17, further comprising:
providing a first side polishing wheel comprising a first side rotation axis and a second side polishing wheel comprising a second side rotation axis parallel to the first side rotation axis; and
moving the plurality of window glasses between the first side polishing wheel and the second side polishing wheel while the plurality of window glasses are in contact with the first and second side polishing wheels to polish side surfaces of the plurality of window glasses.

19. The method of claim 18, wherein the moving of the plurality of window glasses comprises:
rotating the first side polishing wheel to polish edges of the window glass; and
rotating the second side polishing wheel to polish the folding portion of each of the plurality of window glasses, and
wherein the polishing of the edges and the polishing of the folding portion are substantially simultaneously performed.

20. The method of claim 1, further comprising replacing first ions of the polished window glass with second ions different from the first ions to chemically strengthen the window glass.
